(19) United States
(12) Patent Application Publication
(10) Pub. No.: US 2002/0181442 A1
(43) Pub. Date: Dec. 5, 2002

(54) Multimode personal communication system and method

(76) Inventor: Purshotam Rajani, Raleigh, NC (US)

Correspondence Address: JINAN GLASGOW, P O BOX 28539, RALEIGH, NC, 276118539

(21) Appl. No.: 09/866,975

(22) Filed: May 29, 2001

(51) Int. Cl. H04L 12/66; H04L 12/28

(52) U.S. Cl. 370/352; 370/400; 370/338; 370/493

(57) ABSTRACT

A multimode personal communication system including at least one personal communication device (PCD) that communicates via wireless transmitter and receiver with at least one multiplexing communication device (MCD) for transmitting and receiving voice communication with local and remote persons via conventional telephone mode, wireless telephone mode, wireless data mode, and/or dataline data mode, based upon the PCD user's proximity to the at least one MCD and the least cost provider or other predetermined protocol for the particular voice communication. A method of using the system is also included in the present invention.

### BACKGROUND OF THE INVENTION

(1) Field of the Invention

The present invention relates generally to the field of personal telecommunications, and in particular to a location independent personal telecommunications system that utilizes a multimode system that accesses wireless voice, data, and cellular transmission means in order to enable the user to place a call from any service location via a personal communication device through any of the modes and to receive calls through any of the modes regardless of the location of the user.

(2) Description of the Prior Art

The importance and size of the computer and telecommunications industries has generated numerous communication modes, such as conventional telephone mode, wireless telephone mode, computer network, and wireless computer network. Each of these communication modes offers a desirable feature, such as reduced costs, mobility, etc. Subscription by a user to more than one of these modes often results in the need to carry numerous devices in order to receive service via each mode, resulting in an inconvenience, such as excessive weight or volume to be carried and multiple steps to switch between devices. Prior art embodiments have attempted to integrate these modes into a single device.

More particularly, relevant prior art indicates that it is known to provide a portable communication device such as a laptop computer, palmtop or handheld computer, personal digital assistant (PDA), cellular telephone, or cordless telephone. Additionally, it is known to use a method for establishing a wireless link for communication from such a device. Finally, server-based wireless communication between a PC and PDA is known, as is telephonic communication via computer network, user and/or caller identification. Specific citations and brief abstract statements summarizing the main points for each prior art reference are as follows:

U.S. Pat. No. 6,216,013 issued Apr. 10, 2001 to Moore, et al. & assigned to Cable & Wireless PLC for Communication system with handset for distributed processing teaches a communication system, comprising at least one mobile handheld telephone handset adapted to communicate with a telephone network handling system. The handset is capable of voice transmission, speech recognition, and data transmission.

U.S. Pat. No. 6,198,941 issued Mar. 06, 2001 to Aho, et al. & assigned to Lucent Technologies, Inc. for Method of operating a portable communication device teaches a method of effectuating a change in the operation of a portable communication device such as a laptop, palmtop, PDA, or cellular telephone. Various signals indicative of the operating environment are monitored, to anticipate or predict a change or transition from one communication arrangement to the other. If the change is determined to be both imminent and significant, the operation change occurs spontaneously to avoid loss of performance of the device.

U.S. Pat, No. 6,195,564 issued Feb. 27, 2001 to Rydbeck, et al. & assigned to Ericsson Inc. for Method for automatically establishing a wireless link between a wireless modem and a communication device teaches a system and method for automatically establishing or activating a wireless link between a communication device and a wireless modem so that electronic messages can be easily and automatically transferred between the communication device and a data network. The communication device can be a portable computer and the wireless modem can reside in a wireless phone, cellular phone, PCS phone, etc. This invention is especially useful in the situation where the communication device and the wireless modem move in and out of range of the wireless link or each other.

U.S. Pat. No. 6,072,598 issued Jun. 6, 2000 to Tso for Method for enhancing usability of fax on small device teaches a method and system for viewing faxes on a PDA or handheld computer. In a device with limited processor/memory capability such as a PDA, this is a method and system for viewing a facsimile transmission image, by routing the transmission to a computer system for processing before it reaches the device. Processing includes recognizing text and filtering it from the transmission, and outputting it to a transmittal data file to be sent to the device.

U.S. Pat. No. 6,034,621 issued Mar. 7, 2001 to Kaufman & assigned to Lucent Technologies, Inc. for Wireless remote synchronization of data between PC and PDA teaches a system wherein wireless paths between PC and PDA are utilized to synchronize data files between them. A simple and efficient wireless way to synchronize data files on separated computers that do not require a fixed, direct connection to each other; data files can be updated on a frequent, inconspicuous and convenient basis.

U.S. Pat. No. 5,983,073 issued Nov. 9, 1999 to Ditzik for Modular notebook and PDA computer systems for personal computing and wireless communications teaches a small lightweight modular microcomputer based computer and communications systems, designed for portable and desktop use. The systems are capable of bi-directional real-time communications of voice, audio, text, graphics, and video data. Wireless and wire-based communications methods & devices are implemented.

U.S. Pat. No. 6,219,560 issued Apr. 17, 2001 to Eikkila, et al. & assigned to Nokia Mobile Phones Ltd for Modular mobile communication system teaches a mobile communications device constructed to receive an expansion card which allows the user to add a new function in the host device, including external equipment such as the optical unit of a digital camera, which facilitates visual communication in addition to audio/text communication.

U.S. Pat. No. 6,192,258 issued Feb. 20, 2001 to Kamada, et al. & assigned to Access Co. Ltd; Sony Corp. for Mobile communication device with a rotary push switch teaches a mobile communication device with a flat display capable of displaying an HTML document. A personal information list written in HTML is present on the display. Anchor points are set to person names, phone numbers, FAX numbers, and email addresses in the list. Selection of these items with a pen causes their associated operations to be performed.

U.S. Pat. No. 6,188,917 issued Feb. 13, 2001 to Laureanti & assigned to Nokia Mobile Phones Ltd. for Portable telecommunications assembly having user hand-hold, and associated method teaches a communication device combined with a portable radio telephone that operates upon communication media and transceives signals representative of the communication media between the device and a remote station. The communication device includes a docking port into which the portable radiotelephone is insertable, and used as a handhold to support the communication device engaged together with the phone. Permits user of a wireless communication device (PDA) to hold the PDA engaged with a portable radiotelephone.

U.S. Pat. No. 5,528,248 issued Jun. 18, 1996 to Steiner, et al. & assigned Trimble Navigation, Ltd. for Personal digital location assistant including a memory cartridge, a GPS smart antenna and a personal computing device teaches a handheld apparatus (PDA) having a GPS antenna and receiver to provide location information, capable of using standard operating systems to run existing applications, and capable of running programs to provide a mobile professional, personal traveler, or navigator with a display of location and relative locations and attributes of map features proximate to him.

U.S. Pat. No. 6,209,011 issued Mar. 27, 2001 to Vong, et al. & assigned to Microsoft Corp. for Handheld computing device with external notification system teaches a portable handheld computing device has a notification system that alerts a user of an event regardless of whether the device is on or off.

U.S. Pat. No. 5,930,700 issued Jul. 27, 1999 to Pepper, et al. & assigned to Bell Communications Research, Inc. for System and method for automatically screening and directing incoming calls teaches a system that automatically screens and forwards incoming calls to another number or voicemail if necessary according to caller identification information and schedule information in a database; This database is managed in conjunction with the address book and calendar on a PDA. This system does not include any phone functionality on the PDA itself.

U.S. Pat. No. 5,522,089 issued May 28, 1996 to Kikinis, et al. & assigned to Cordata, Inc. for Personal digital assistant module adapted for initiating telephone communications through DTMF dialing teaches a system that, among other functions, generates DTMF tones in a PDA using special strings of text output to the speaker.

U.S. Pat. No. 5,940,479 issued Aug. 17, 1999 to Guy, et al. & assigned to Northern Telecom Limited for System and method for transmitting aural information between a computer and telephone equipment teaches a system that provides a gateway between PC-based phones on a computer network and a conventional phone system; This system does not include intelligent switching capabilities between multiple phone networks or any provision for communicating directly with wireless devices.

U.S. Pat. No. 5,889,845 issued Mar. 30, 1999 to Staples, et al. & assigned to Data Race, Inc. for System and method for providing a remote user with a virtual presence to an office teaches a server set up at an office can be contacted by a remote user via his home phone line; the server will treat a remote user as if (s)he were at the office, automatically routing all calls, e-mails, and faxes to the remote user.

U.S. Pat. No. 6,185,291 issued Feb. 6, 2001 to Miloslavsky & assigned to Genesys Telecommunication Laboratories, Inc. for Personal desktop router teaches a software package designed to route calls on a local telephone system based on caller ID information on the incoming calls. Individual copies of the software on all users' computers communicate with a server to determine how calls are routed for that user. Users can modify rules for the routing of their calls.

U.S. Pat. No. 6,169,791 issued Jan. 2, 2001 to Pokress & assigned to Mediacom Corp. for System and method for least cost call routing and U.S. Pat. No. 5,799,072 issued Aug. 25, 1998 to Vulcan, et al. & assigned to CallManage for Telecommunications Call Management System teach similar inventions: A system that stores information about rates of commercial, landline long distance carriers; users download this information and software enables them to select the lowest-cost route for any given call based on location and pricing structure. Note that this invention has no provisions for wireless operation.

U.S. Pat. No. 5,878,334 issued Mar. 2, 1999 to Zicker & assigned to GTE Wireless Service Corp. for Module for selectively providing wireless call communications services; U.S. Pat. No. 5,887,259 issued Nov. 21, 2000 to Zicker & assigned to GTE Wireless Service Corp. for Multiple mode personal wireless communications system; and U.S. Pat. No. 6,151,510 issued Nov. 21, 2000 to Zicker & assigned to GTE Wireless Service Corp. for Module for providing wireless call communication services through wire-connected telephone equipment. These three patents teach a similar systems: A system that automatically switches calls between a cellular system and cordless landline system depending on the location of the caller; this system does not compute the lowest-cost option for placing a call.

U.S. Pat. No. 5,315,636 issued May 24, 1994 to Patel & assigned to Network Access Corp. for Personal Telecommunications System teaches a system that allows a user to have one telephone number for both an office and wireless phone; incoming calls are routed to the user based on the last known location of the user. This system will route calls to third party phone numbers if that number is the last known location of the user.

Thus, although the prior art can integrate different modes of communication, it inadequately integrates multiple modes and advanced features into a single device and system. For instance, prior art integrates wireless telephone service with cordless landline telephone service providing a device that can automatically switch between wireless and landline protocols depending on the proximity of the user to his landline telephone connection. Such devices do not integrate with newer voice-over-IP (Internet Protocol) technology nor do they allow incoming calls to be routed to other landline telephone numbers than the user's own personal landline connection. Additionally, although some prior art teaches the use of Session Initiation Protocol (SIP) and the H323 Protocol that can route data through a gateway to a Public Switched Telephone Network, or PSTN, the prior art does not teach the routing of data to a portable communication device. Thus, the prior art systems provide only partial integration of the available communication modes and do not provide full integration with advance modes and features.

Thus, there remains a need for a multimode personal communication system for transmitting and receiving calls or voice communication with local and remote persons via conventional telephone mode, wireless telephone mode, computer network, cordless telephone, and/or wireless computer network based upon the personal communication device user's proximity to a multiplexing, multimode communication device and the predetermined provider for the particular voice communication.

### SUMMARY OF THE INVENTION

The present invention is directed to a multimode personal communication system for transmitting and receiving calls or voice communication with remote persons via conventional telephone mode, wireless telephone mode, wireless data mode and/or dataline data mode, based upon the personal communication device user's proximity to a multiplexing, multimode communication device and the predetermined provider for the particular voice communication.

In a preferred embodiment, at least one personal communication device, or PCD, is in wireless communication with at least one multiplexing communication device, or MCD, for the transmission and reception of calls or voice communication with remote persons via landline telephone, wireless computer network, or wired computer network. When not in the presence of an MCD, a PCD is in communication with a wireless telephone system, wireless or wired computer network, or cordless telephone system.

The present invention is further directed to a method for using the system. These and other aspects of the present invention will become apparent to those skilled in the art after a reading of the following description of a preferred embodiment when considered with the drawings.

### BRIEF DESCRIPTION OF THE DRAWINGS

FIG. 1 is a block diagram of a system/network constructed according to the present invention.

### DEFINITIONS

Throughout this document, specific terms shall be defined as follows: “External” shall refer to something that exists outside the present invention such as the Internet or a PSTN (Public Switched Telephone Network). For example, the “external telephone system” shall refer to the telephone network interconnected throughout the world that allows users to contact one another using a numerical code, which represents a particular landline telephone system or wireless telephone as defined below. “External Modes” shall refer to all those modes of communication outside the present invention, such as the “external telephone system”, the Internet, and other modes of communication.

A “landline telephone” system shall refer to a conventional wired telephone system including commercial Private Branch Exchange (PBX) systems and residential and commercial wired phone lines.

A “cordless telephone” shall refer to a specific type of “landline telephone” as defined above wherein a connection between a handset or headset and a base unit is a wireless connection. Only a small number of handsets communicate with a small number of base units. “Cordless telephone” systems as opposed to “wireless telephone” systems defined below shall be those that are designed to operate over a short distance, for instance, within the confines of one home or business location, and are not designed to automatically switch between base units when the user moves from place to place. In a multi-line “cordless telephone” system, each base unit is assigned a unique telephone number depending on how it is connected to the external telephone system.

A “wireless telephone” shall refer to a telephone designed to communicate with multiple base units depending on the location of the user and shall include those systems traditionally referred to as “mobile telephones”, “cellular telephones”, and “digital cellular telephones”. Like “cordless telephones”, “wireless telephones” shall refer to systems where the connection between a handset and a base unit is wireless. “Wireless telephones” as opposed to “cordless telephones” shall refer to those telephone systems wherein each handset or small group of handsets is assigned a unique number and is designed to communicate with the nearest compatible base unit to the location of the user. Newer technologies not specifically mentioned here that fit this description of a “wireless telephone” shall be referred to by the term “wireless telephone” in this document. The adaptation of newer wireless technologies to the present invention will be obvious to one skilled in the art.

An “analog cellular telephone” shall refer to a specific type of “wireless telephone” wherein the wireless connection between a handset and a base unit is an analog radio frequency connection.

A “digital cellular telephone” shall refer to a specific type of “wireless telephone” wherein the wireless connection between a handset and a base unit is a digital radio frequency connection. “Digital cellular telephone” shall refer to any of several existing digital communications protocols as well as other protocols that may be developed in the future. Newer technologies that fit this description of “digital cellular telephone” shall be referred to by the term “digital cellular telephone” in this document. The adaptation of newer digital communications methods to the present invention will be obvious to one skilled in the art.

A “computer network” shall refer to any group of interconnected computers including a local area network, or LAN, wide area network, or WAN, and the internet. A “computer network” shall refer to computers connected via any means, including DSL, cable modem, T1, T3, V.90, X2, 10baseT, 100baseT, and other protocols and methods.

A “wireless computer network” shall refer to a specific type of “computer network” wherein the connections between the computers in the network are wireless. A “wireless computer network” shall refer to networks connected on any radio frequency or optical communications band and networks connected via any protocol including, IEEE 802.11b, also known as Wi-Fi™, Bluetooth, and other protocols.

A “transceiver” shall refer to a combination of a transmitter and receiver capable of communicating with another transceiver also including a combination of a transmitter and a receiver to provide bi-directional communication between two communications devices.

A “softPBX” server shall refer to a server with PBX functionality performed by software running on the server.

### Detailed Description of a Preferred Embodiment

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

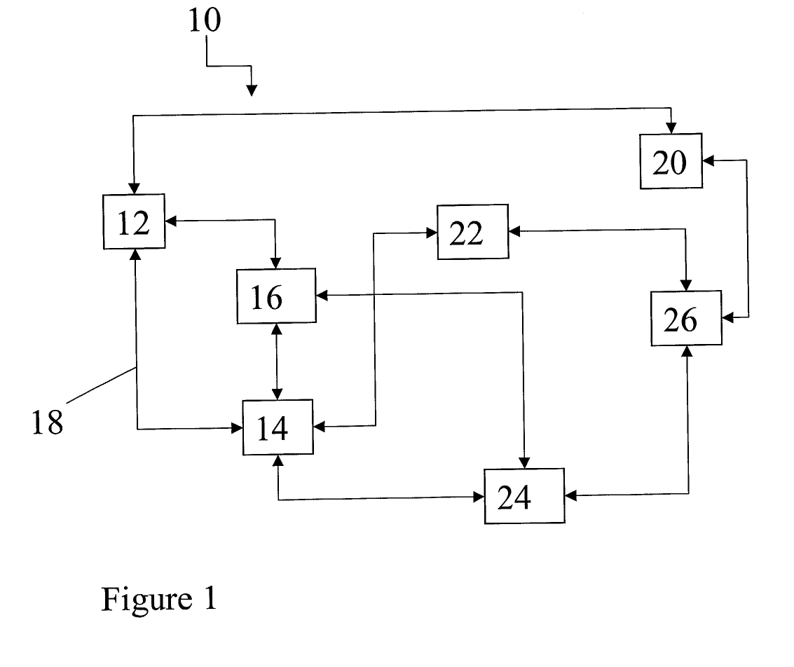

Referring now to the drawings in general, the illustrations are for the purpose of describing a preferred embodiment of the invention and are not intended to limit the invention thereto. Referring now to FIG. 1, there is shown a block diagram for the multimode personal communication system, generally referenced as 10, that includes at least one personal communication device 12, or PCD, communicating with at least one multiplexing communication device 14, or MCD. The PCD and MCD can communicate with one another via a wireless computer network 16, or other means 18, including a wired computer network, direct telephone cable, or wireless connection using cordless telephone protocol. The PCD can also communicate with other wireless voice transmitter/receivers 20. The MCD can offer communication via landline telephone line 22 and computer network 24. Thus, the MCD system can transmit and receive voice communication with external communication systems 26 via landline telephone and via computer network using one of several methods and protocols for such communication. The PCD can access the modes connected to an MCD or a PCD can function alone as a landline telephone, cordless telephone, wireless telephone, a node on a computer network, or a node on a wireless computer network depending on the embodiment of the invention and the connections available to the PCD.

The PCD includes a speaker, a microphone, at least one transmitter/receiver for transmitting and receiving information, a battery for power, a data entry system for entering information, a microprocessor, and a memory as required for operation of the microprocessor. In a preferred embodiment, the transmitter/receiver is a radio frequency antenna, the battery is a rechargeable, extended-life battery, and the data entry device is a touchpad. Alternatively or additionally, the transmitter/receiver may be an optical transmitter/receiver. Such an optical transmitter/receiver can use infrared frequencies for the transmission of information. Alternately or additionally, the transmitter/receiver can be a wired computer network device. Additionally, the PCD includes the features of a personal digital assistant, or PDA, to store, process, and display various types of information that may be of use to the user. To this end, the PCD includes additional memory for the storage of information. In a preferred embodiment of the present invention, the PCD includes at least eight Megabytes of memory, which may be expandable as necessary to accommodate additional functions and/or processing.

Because the PCD is portable and can be used to transmit personal information, the PCD may include at least one security system, including user identification means or UIM for identifying a pre-approved user of the device. The at least one UIM may include user identification and passcode, key code devices, and/or biometric identification means for identifying a pre-approved user of the PCD. The biometric user identification means may be voice-based, fingerprint-based, and the like, and combinations thereof. In addition to preventing the loss of personal information and/or unauthorized access or use of the PCD, the user identification means allows multiple users to use the device and preserve the security of the other users' information. Because a user may have more than one user ID on the PCD, each associated with a specific occupation, hobby, location, priority level, or the like, the user will need to be able to determine to which user ID an incoming call has been placed. Therefore, for any given incoming call, the PCD displays the specific user ID of the called user, herein referred to as the “Called ID”. The PCD does not necessarily communicate the Called ID via the display, but can use other systems, such as different tones for different user IDs. Alternately or additionally, because the PCD can receive calls placed to various numbers or computer addresses, the PCD displays the specific telephone number or computer address called by a calling party.

In a preferred embodiment, the PCD also functions as a telephone, providing voice telecommunication service to the user. The PCD can use a variety of communication means without the aid of an MCD, including landline telephone, wireless telephone, both wireless and wired computer network, and the like. Thus, the PCD can function as a landline telephone, a wireless telephone, a cordless telephone, or a voice-over-IP transceiver when connected to a computer network, wireless or otherwise, and the like.

In a preferred embodiment, the communication transmitted over the multimode communication system is encrypted to prevent unauthorized access to the information. In a preferred embodiment, the encryption is performed asymmetrically via a method such as the Public/Private Key Encryption method. In this method, public keys are exchanged between users. These public keys are stored in the PCD, preferably cached in the address book and associated with the proper contact number. Thus, a preferred embodiment according to the present invention includes asymmetric encryption of voice communication. Furthermore, the encryption is running on the multimode communication system as the default setting. This is in contrast to other systems, such as the IEEE 802.11b protocol, wherein the encryption is symmetric encryption only and needs to be activated prior to use.

The PCD includes a PDA to store, process, and display various information. One of the functions of the PDA includes an address book to retain and display the names, street and electronic addresses, and telephone numbers of the user's contacts. The address book interfaces with the telephone functions of the PCD, such that a contact number can be selected in the address book for auto/speed dial. Information can be inputted into the PDA by a variety of means; for example, data can be inputted by typing, touch pen, speaking or voice-recognition, and electronic file transfer. The PDA may also include a personal information manager, or PIM. The PIM is capable of maintaining and transmitting the user's personal information. For example, the PIM can transmit and receive users' public keys for encryption, credit card numbers and authorization codes to vendors for transactional purposes. Also, the PIM is capable of transmitting digital signatures, such as digital certificates, to authenticate the caller. The transmission of digital signatures and other types of identification information can be performed automatically at the initiation of the call, or manually during the communication.

The multiplexing communication device or MCD includes a telephone network handling system. In a preferred embodiment, the MCD functions as a multiplexing, Private Branch Exchange, or PBX, server capable of routing communication via telephone or data communication modes. The routing is performed by software running on the server. Thus, the MCD is a softPBX server. The communication modes include landline telephone lines, wireless telephone, computer network lines, DSL lines, cable lines, T1 lines, and the like.

In a preferred embodiment, the multiplexing communication device includes a multiplexing server. Preferably, the multiplexing server includes the functionality of a PBX server using the 2.4 Gigahertz frequency band for communication the IEEE 802.11b, Bluetooth, or other protocol to communicate with personal communication devices. Additionally, the MCD can transmit 7-22 Megabits/sec and can support up to 1024 PCDs. Thus, the MCD is capable of providing a wireless communications Internet protocol or IP hub. The wireless IP hub can use a protocol such IEEE 802.11b, Bluetooth, and the like. Thus, the MCD is capable of providing both voice telephone access and access to a computer network through the use of a single wireless IP connection with a personal communication device. More specifically, the MCD may provide voice over IP telephony using the IEEE 802.11b protocol. Thus, in a preferred embodiment, the PCD is a Wi-Fi™ telephone. In another embodiment, an MCD can communicate with a PCD using cordless telephone protocols to provide access to voice telephone lines. Thus, the MCD is capable of transmitting voice telephony over a multiplicity of connections.

In a preferred embodiment, multiplexing communication devices are located in office, home, and foreign sites. Foreign sites are those where the user is not primarily based, such as at the offices of organizations different from the user's organization. An MCD detects PCD's in its proximity, determines the users of each PCD and the primary MCD for that user, and transmits the users' locations back to each user's primary MCD so that a call can be forwarded to the user. In a preferred embodiment, detection is automatic, but may include a manual override, e.g., when the PCD user is at home and does not prefer to have work-related calls to be automatically forwarded to the home MCD after business hours. Alternatively, the forwarding may be automatically selective based on the user's location, time of day, or date. For example, if the PCD user is at home during business hours, a call to the user's office number will be automatically forwarded to the home MCD. After a predetermined hour, such as after the end of normal working hours, the office MCD no longer automatically forwards calls to the home MCD. Such a system can be especially convenient to users who periodically work at home. Thus, a preferred embodiment according to the present invention provides selective, predetermined, automatic call forwarding for multiple numbers for called ID(s), including proximity-based, selective, predetermined, automatic call forwarding. Additionally, when a user leaves the range of an MCD or other communications mode, the PCD can be automatically switched to another MCD or another mode. For example, a user that is leaving the range of an MCD can be switched to a cellular protocol, as taught in U.S. Pat. No. 6,198,941 issued to Aho, et al. and incorporated herein by reference in its entirety.

The multimode personal communication system includes operating software that confers a multiplicity of functions to enhance the ease of use of the PCD. In a preferred embodiment, the MCD selects the mode to route the call based on user preferences. The user preferences may be predetermined or determined at the time of placing the call. For example, the MCD can be programmed to select the mode to route the call through based on the cost of service. Alternatively, the MCD can select the mode to route the call based on the performance of the modes. For example, if one of the modes is functioning at less than optimal performance, the MCD can route the call through another mode. In a preferred embodiment, the MCD selects the mode to route the call based on the range of the call, wherein the range is either a toll-free call, including local communication, or a toll call, such as a long-distance call. The MCD may also select the mode to route the call through based on the identity of the user. For example, a local user, one whose primary MCD is the accessed MCD, may be provided access to all the communication modes, whereas a foreign user, one whose primary base is different from the local base being accessed and is thus accessing a foreign MCD, may have access only to local communication and the foreign user's subscriber account on an internet based, voice-over-IP telephone gateway service.

The MCD may provide a variety of accessory functions for the user's or system manager's benefit. In a preferred embodiment of the present invention, the MCD is a softPBX server that is capable of providing a log of call times, call lengths, and call modes. The softPBX server also identifies the called party by telephone number and name. The softPBX server also provide communication features selected from the group consisting of caller ID, voice mail, call forwarding, call hold, hold music, directory assistance, paging, peer-to-peer communication, call transfer, and the like. Peer-to-peer communication allows direct transfer between users; the direct transfer may be made using a number, e.g. an extension, or using a name of the other individual. The MCD can allow direct call transfer to peers and to foreign users via the PDA. A foreign user is one whose primary base is not the receiver's current location. Thus, a user may receive a call from a foreign caller and transfer the caller to a third user at a second foreign site. Additionally, the user may perform this function while away from his/her primary base and communicating with a foreign server. This call transfer action can be performed by selecting a third user's number and/or mode from the third user's communication file and instructing the MCD to transfer the incoming call to the third user. Additionally, communication directory files are downloadable to the PDA via the MCD for use in information retrieval and speed dialing.

In a preferred embodiment, the MCD includes at least two main functions, a switching function that routes communication between the various modes and connections to it, and a routing function that determines how calls are routed. The components that perform these two functions need not be located in the same place, but they could be. For instance, switching function components could be in a housing connected to a computer network and routing function components could be software on a computer connected to the same network. The switching function components would communicate with the routing function components over the computer network. In another embodiment, the MCD would include both the switching function components and the routing function components in the same housing.

In another embodiment, the call routing server exists on a computer on a local area network (LAN). Connections to PCDs are established using a wireless IP hub using a protocol such as IEEE 802.11b or Bluetooth. A connection to a wide area computer network such as the internet is supplied directly to the LAN using DSL, T1, T3, X2, V.90, or another internet connection protocol or method. Multiple wireless IP hubs using the IEEE 802.11b protocol could be added to the network to provide connections to a large number of PCDs, thereby providing one means of scalability for the system.

The invention is further directed to a method for multimode personal communication, including the steps of:

Providing a multiplexing communication device capable of communicating with other communication systems via various communication modes including landline telephone, computer network, cordless telephone, and wireless computer network for routing incoming calls to system users and for routing outgoing calls from system users

Providing a PCD that communicates with the multiplexing server via wireless computer network, wired computer network, landline telephone, and cordless telephone wherein for routing outgoing calls from system users:

Receiving a call initiation request from PCD;

Determining the mode to transmit the call,

Transmitting the communication received and initiated by the system over the selected mode using the system set forth in the foregoing;

and wherein for routing incoming calls to system users:

Receiving a call from an external communication system:

Determining the best route from the MCD to the PCD,

Routing the communication received and initiated by the system over the selected mode using the system set forth in the foregoing.

Certain modifications and improvements will occur to those skilled in the art upon a reading of the foregoing description. By way of example, using the PDA to forward calls to another number during scheduled meetings. Also, when not located in close proximity to a user's primary MCD, a user may access a generic wireless computer network using a wireless protocol such as EEE 802.11b or Bluetooth to connect to a user's primary MCD when a foreign MCD is also not in close proximity. All modifications and improvements have been deleted herein for the sake of conciseness and readability but are properly within the scope of the following claims.

I claim:

1. A multimode communication system for location independent communications comprising at least one personal communication device (PCD) comprising:
integrated components for producing and receiving a wireless signal;
a speaker;
a microphone;
a transceiver for transmitting and receiving information;
a microprocessor and memory for processing information;
a battery for power;
and a means of data entry;
the at least one PCD having a display and being capable of communicating with at least
one multiplexing communication device (MCD) comprising:
at least one transceiver for communicating with the at least one personal communication
device;
at least one connection to external communications systems;
a call routing server managing communications with the at least one personal communication device and the at least one connection to an external communication system;
wherein the system can transmit and receive communication via at least one external communications systems thereby providing a location independent personal telecommunications system.

2. The system according to claim 1 wherein the at least one transceiver is a radio frequency transceiver.

3. The system according to claim 1 wherein the at least one transceiver is an optical transceiver.

4. The system according to claim 3 wherein the at least one optical transceiver operates on infrared frequencies.

5. The system according to claim 1 wherein the means of data entry further includes a keypad.

6. The system according to claim 1 wherein the means of data entry further includes a voice activated system.

7. The system according to claim 1 wherein the at least one MCD provides voice telephony over a wireless computer network.

8. The system according to claim 7 wherein the at least one MCD provides Voice Over IP communications over a wireles s computer network using IEEE 802.11b protocol.

9. The system according to claim 1 wherein the at least one PCD further includes a personal digital assistant.

10. The system according to claim 9 wherein the personal digital assistant further includes an address book wherein entries in the address book can be speed dialed.

11. The system according to claim 1 wherein the at least one PCD further includes a personal information manager for securely storing and transmitting personal information.

12. The system according to claim 11, wherein the personal information is at least one public key for asymmetric digital voice and data encryption.

13. The system according to claim 11 wherein the personal information manager comprises:
a memory for storing personal data;
a program for managing the personal data and transmitting the personal data.

14. The system according to claim 1 wherein the at least one PCD further includes a secure user identification system for allowing multiple users to access the same PCD.

15. The system according to claim 14 wherein the secure user identification system is biometric.

16. The system according to claim 15 wherein the biometric user identification system is selected from the group consisting of voice-based identification, fingerprint-based identification, and combinations thereof.

17. The system according to claim 14 wherein the system indicates the called user's telephone identification.

18. The system according to claim 1 wherein the at least one PCD further includes a telephone.

19. The system according to claim 18 wherein the telephone is a cordless telephone.

20. The system according to claim 18 wherein the telephone is a wireless telephone.

21. The system according to claim 20 wherein the wireless telephone is a digital cellular telephone.

22. The system according to claim 18 wherein the telephone is a voice over IP device.

23. The system according to claim 1 wherein the memory is at least eight megabytes large.

24. The system according to claim 1 wherein the memory is user expandable.

25. The system according to claim 1 wherein the at least one MCD selects which at least one connection to external communications systems will be used for a given call.

26. The system according to claim 25 wherein the at least one MCD selects the connection based on cost of service.

27. The system according to claim 25 wherein the at least one MCD selects the connection based on current percentage usage of maximal capacity of each at least one connection.

28. The system according to claim 25 wherein the at least one MCD selects the connection based on the range of the call.

29. The system according to claim 25 wherein the at least one MCD selects the connection based on the identity of the user of the PCD from which the call is placed.

30. The system according to claim 1 wherein the at least one MCD is a multiplexing server.

31. The system according to claim 1 wherein the at least one MCD further includes a softPBX server.

32. The system according to claim 31 wherein the softPBX Server operates on radio frequencies and uses the IEEE 802.11b protocol.

33. The system according to claim 31 wherein the softPBX Server is capable of transmitting between about 7 and 22 Megabits per second.

34. The system according to claim 31 wherein the softPBXServer's PCD capacity is limited only by limitations of the microprocessor and memory.

35. The system according to claim 31 wherein the softPBX Server is capable of identifying a called user by telephone number and user ID.

36. The system according to claim 31 wherein the softPBX Server can provide communication features selected from the group consisting of caller ID, voice mail, call forwarding, call hold, hold music, directory assistance, paging, speed dialing, and combinations thereof.

37. The system according to claim 1 wherein the system is capable of providing peer to peer communication between at least two of the at the least one PCDs.

38. The system according to claim 37 wherein the peer to peer communication is capable of occurring directly between at least two of the at least one PCDs.

39. The system according to claim 38 wherein the direct peer to peer communication is referenced by the names of the users of at least two of the at least one PCDs.

40. The system according to claim 1 wherein the at least one MCDs are located in office and residential sites and foreign sites.

41. The system according to claim 1 wherein each of the at least one MCD detects the at least one PCDs in close proximity, transmits the location of each the at least one PCDs to the primary MCD with which each PCD is associated, and the primary MCD for each PCD forwards calls intended for the user of each PCD to the MCD in closest proximity to each PCD.

42. The system according to claim 41 wherein the detection of PCDs and transmission of the location of each PCD to the primary MCD for each PCD is automatic.

43. The system according to claim 41 wherein call forwarding is automatic.

44. The system according to claim 43 wherein automatic call forwarding can be overridden by the user of each PCD.

45. The system according the claim 43, wherein the automatic call forwarding is selective and predetermined.

46. The system according to claim 45, wherein the selective, predetermined, automatic call forwarding is based on criteria selected from the group consisting of user location, time, date, user call routing preferences, and combinations thereof.

47. The system according to claim 1 wherein the at least one MCD further includes a wireless Internet Protocol (IP) hub running a communications Internet Protocol.

48. The system according to claim 47 wherein the wireless IP hub uses a protocol selected from the group consisting of Bluetooth and IEEE 802.11b.

49. The system according to claim 1 wherein the at least one connection external communications systems includes a connection to a landline telephone system.

50. The system according to claim 1 wherein the at least one connection to external communications systems includes a connection to a computer network.

51. The system according to claim 1, further including a means for encrypting the transmitted voice.

52. The system according to claim 51, wherein the encrypting means uses asymmetric encryption.

53. The system according to claim 1, wherein the at least one user can have at least one user ID.

54. The system according to claim 53, wherein each at least one user ID is associated with a different set of call routing preferences.

55. The system according to claim 54, wherein the multiple user IDs are used to provide selective, predetermined, automatic call forwarding.

56. The system according to claim 53 wherein the active user ID is automatically selected based on the location of the user.

57. A method for multimode personal communication, including the steps of providing a multiplexing server with landline telephone connections and computer network connections;
providing a personal communications device that communicates with the multiplexing
server via wireless and wired communications media;
and transmitting communication received and initiated by the system over the landline and computer network connections thereby providing a location independent telecommunications system.

58. The method according to claim 57 further including the steps of detecting the PCD's in close proximity to an MCD;
transmitting the location of the PCD's in close proximity to an MCD to the primary MCD for each PCD;
forwarding the calls intended for the user of each PCD to the PCD of each user.

59. The method according to claim 58, further including the step of selective, predetermined, automatic call forwarding.

60. The method according to claim 59, wherein the selective, predetermined, automatic call forwarding is based on criteria selected from the group consisting of user location, time, date, and combinations thereof.

61. The method according to claim 57, further including the step of asymmetric encryption of the transmitted voice using the public/private key encryption method.

62. The method according to claim 57, further including the step of communicating the called ID.
